(19) United States
(12) Patent Application Publication
(10) Pub. No.: US 2026/0051017 A1
(43) Pub. Date: Feb. 19, 2026

(54) EFFICIENT CACHING OF UNIVERSAL FEATURES FOR MULTIPLE DECODER TASKS IN MACHINE LEARNING

(71) Applicant: QUALCOMM Incorporated, San Diego, CA (US)

(72) Inventors: Titash RAKSHIT, Austin, TX (US); Mohsen GHAFOORIAN, Diemen (NL); Alin-Eugen DONDERA, Amsterdam (NL)

(21) Appl. No.: 18/802,854

(22) Filed: Aug. 13, 2024

(51) Int. Cl. G06T 1/60; G06V 10/771; G06V 10/82; G06V 10/94; G06V 10/96; H04N 19/189

(52) U.S. Cl. CPC G06T 1/60; G06V 10/771; G06V 10/955; G06V 10/96; H04N 19/189; G06V 10/82

(57) ABSTRACT

Aspects of the disclosure are directed to multitask machine learning (ML). In accordance with one aspect, the disclosure includes executing, by a first machine learning (ML) task, a machine learning (ML) feature encoding of a selected feature to generate a common feature tensor, without an external memory access, accessing, by a second machine learning (ML) task, the common feature tensor from a local non-transitory memory; and decoding the common feature tensor for completion of the second ML task.

### TECHNICAL FIELD

This disclosure relates generally to the field of machine learning (ML) information processing, and, in particular, multi-task learning (MTL) for multiple decoder tasks.

### BACKGROUND

Machine learning (ML) may involve deep learning techniques which use a plurality of concurrent ML models for a desired end user experience in many applications, such as extended reality (XR). However, deployment and execution of the plurality of concurrent ML models may be a significant resource demand. Efficient Machine learning (ML) model methodology improves extended reality (XR) performance.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides multitask machine learning (ML). Accordingly, the present disclosure discloses an apparatus including: a non-transitory memory for storage of a common feature tensor; a processing engine coupled to the non-transitory memory, the processing engine configured to: a) execute, by a first machine learning (ML) task, a machine learning (ML) feature encoding of a selected feature to generate the common feature tensor; b) without an external memory access, access by a second machine learning (ML) task the common feature tensor from the non-transitory memory, wherein the non-transitory memory is a local memory; and c) decode the common feature tensor for completion of the second ML task.

In one example, the processing engine is further configured to use an encoding algorithm with a specified spatial resolution and frame rate for executing the machine learning (ML) feature encoding. In one example, the processing engine is further configured to: access, by the second ML task, one image frame of a plurality of image frames within a first pickup time; and select, by the second ML task, the one image frame after a first key frame selection latency time. In one example, the processing engine is further configured to: perform a machine learning (ML) preprocessing for a selected feature from the one image frame after a failed local memory access; and select the one image frame after a second key frame selection latency time.

Another aspect of the disclosure provides a method including: executing, by a first machine learning (ML) task, a machine learning (ML) feature encoding of a selected feature to generate a common feature tensor; without an external memory access, accessing, by a second machine learning (ML) task, the common feature tensor from a local non-transitory memory; and decoding the common feature tensor for completion of the second ML task.

In one example, the ML feature encoding uses an encoding algorithm with a specified spatial resolution and frame rate. In one example, the common feature tensor is a multidimensional data structure with one or more attributes of an entity in a machine learning (ML) model. In one example, the method further includes storing the common feature tensor in the local non-transitory memory. In one example, the local non-transitory memory is accessible to a plurality of machine learning (ML) tasks.

In one example, the method further includes accessing, by the second ML task, one image frame of a plurality of image frames within a first pickup time. In one example, the one image frame is an anchor frame used as a reference for subsequent image frames of the plurality of image frames.

In one example, the method further includes selecting, by the second ML task, the one image frame after a first key frame selection latency time. In one example, the method further includes performing a machine learning (ML) preprocessing for a selected feature from the one image frame after a failed local memory access. In one example, the method further includes selecting the one image frame after a-second key frame selection latency time. In one example, the method further includes accessing, by the first ML task, the one image frame within a second pickup time. In one example, the method further includes receiving the plurality of image frames from a sensor for a multitask machine learning (ML) system with the plurality of machine learning (ML) tasks.

Another aspect of the disclosure provides a non-transitory computer-readable medium storing computer executable code, operable on a device including at least one processor and at least one memory coupled to the at least one processor, wherein the at least one processor is configured to implement multi-task learning, the computer executable code including: instructions for causing a computer to execute, by a first machine learning (ML) task, a machine learning (ML) feature encoding of a selected feature to generate a common feature tensor; instructions for causing the computer to, without an external memory access, access by a second machine learning (ML) task the common feature tensor from a local non-transitory memory; instructions for causing the computer to decode the common feature tensor for completion of the second ML task; and instructions for causing the computer to store the common feature tensor in the local non-transitory memory.

In one example, the non-transitory computer-readable medium further includes: instructions for causing the computer to access, by the second ML task, one image frame of a plurality of image frames within a first pickup time; and instructions for causing the computer to select, by the second ML task, the one image frame after a first key frame selection latency time.

In one example, the non-transitory computer-readable medium further includes: instructions for causing the computer to perform a machine learning (ML) preprocessing for a selected feature from the one image frame after a failed local memory access.

In one example, the non-transitory computer-readable medium further includes: instructions for causing the computer to elect the one image frame after a second key frame selection latency time; and instructions for causing the computer to access, by the first ML task, the one image frame within a second pickup time.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example information processing system.

FIG. 2 illustrates an example depiction of multiple machine learning (ML) models running on a processing engine.

FIG. 3 illustrates an example multitask machine learning (ML) model with a universal feature encoder in a local memory.

FIG. 4 illustrates an example multitask machine learning (ML) model with caching of feature encoders.

FIG. 5 illustrates an example timeline for a plurality of machine learning (ML) tasks running on a processing engine.

FIG. 6 illustrates an example flow diagram for implementing a multitask machine learning (ML).

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

An information processing system, for example, a computing system with multiple slices (e.g., processing engines) or a system on a chip (SoC), may be used for machine learning (ML). In general, the information processing system may execute at least two ML stages: a learning stage (i.e., training stage) and an inference stage.

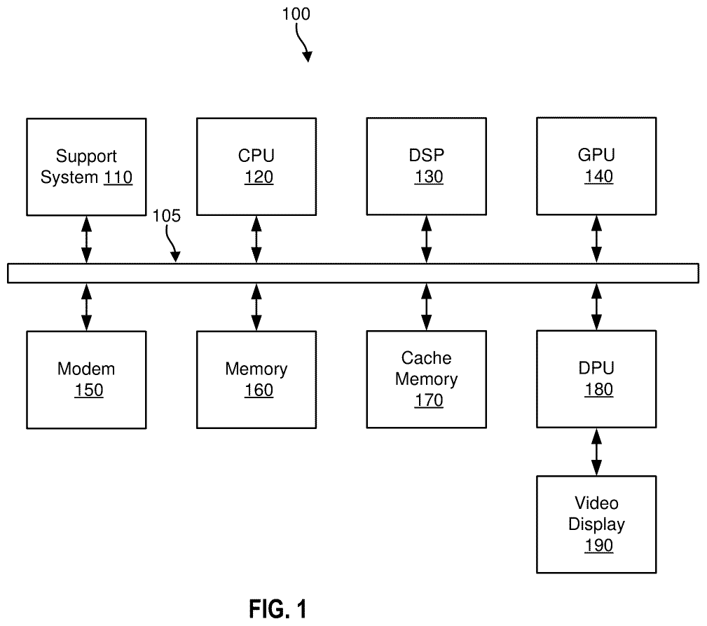

FIG. 1 illustrates an example information processing system 100. In one example, the information processing system 100 includes a plurality of processing engines such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by an interconnection databus 105 to transport data and control information. For example, the memory 160 and/or the cache memory 170 may be shared among the CPU 120, the GPU 140 and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory which is not shared with the other processing engines.

In one example, the information processing system 100 may also include a neural processing unit (NPU). In one example, the NPU is a specialized processing engine optimized for neural processing operations including machine learning (ML) and artificial neural network execution. For example, the NPU may be architected for improved computational throughput with lower precision suitable for neural processing tasks. For example, the NPU may be used to execute machine learning (ML) tasks.

In one example, machine learning (ML) is an alternative computing paradigm where a decision or inference may be made by an information processing system based on an a priori learning or training stage. For example, the learning stage may rely on empirical data which relates a plurality of output data to a given plurality of input data. In one example, the learning stage uses empirical stage to synthesize or tune a ML model to represent a mapping from the given plurality of input data to the plurality of output data. For example, the ML model may be an artificial neural network.

In one example, ML may utilize a plurality of concurrent ML models during the learning stage. In one example, the plurality of concurrent ML models is based on deep learning. For example, an artificial neural network includes an input layer, at least one hidden (e.g., intermediate) layer and an output layer. For example, a deep learning artificial neural network may include multiple hidden layers. In one example, the artificial neural network provides an adaptive mapping between the input layer and the output layer.

In one example, usage of the plurality of concurrent ML models in a computing platform such as a system on a chip (SoC) may impose severe resource and dc power burdens. In one example, context switching between multiple, concurrent ML models may incur eviction, and subsequent reading, of each ML model from a local memory to external memory. In one example, local memory may be cache memory or vector tightly coupled memory (VTCM), and the local memory is coupled locally to the computing platform. In one example, external memory may be double data rate (DDR) memory. In one example, the local memory is a non-transitory memory.

In one example, machine learning (ML) may process features, where a feature is property or characteristic of an information source (e.g., an audio signal, an image, a video sequence, etc.) or of an entity stored in the information processing system. In one example, a feature may be encoded into a numerical value using a feature encoder (i.e., encoder). In one example, the feature may be recovered from the numerical value using a feature decoder (i.e., decoder). For example, the feature encoder may provide a first mapping from a set of categorical features (e.g., color, size, etc.) to a set of numerical values (e.g., positive integers). For example, the feature decoder may provide a second mapping from the set of numerical values to the set of categorical features.

In one example, a multitask learning (MTL)-based ML model with a common feature encoder may be employed. In one example, the common feature encoder extracts universal features from an information source at different spatial resolutions. In one example, the universal features are next ingested by multiple task-specific feature decoders for subsequent ML tasks. In one example, common features of the common feature encoder may need recalculation whenever there is a service demand from the multiple-task-specific decoders. For example, the multiple task-specific decoders may have different frame rate (i.e., frames per second) requirements that complicate usage of multitask learning.

In one example, an alternative MTL-based ML model methodology may be used for improved execution efficiency in terms of memory access bandwidth and associated dc power consumption. In one example, a first element of the alternative methodology is caching universal feature tensors extracted from the feature encoder of the MTL-based ML model. In one example, caching is storage in a local memory (e.g., cache memory). For example, the universal feature tensors do not require cache eviction to an external memory if multiple feature decoders consume the universal feature tensors downstream. In one example, a second element of the alternative methodology is an efficient caching mechanism of the extracted universal feature tensors which are reused based on prior availability in the local memory. In one example, any feature decoder may query the local memory at any time and request the required feature tensors, if available.

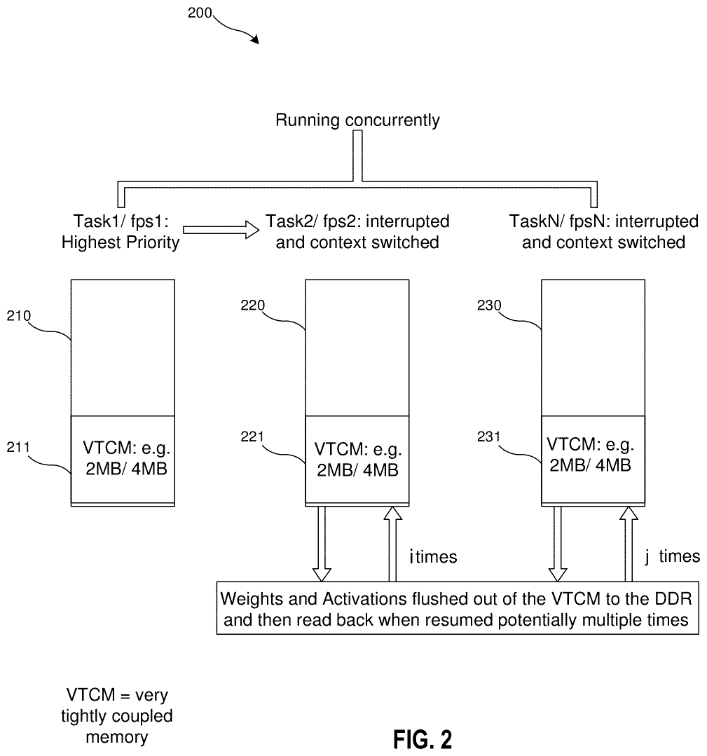

FIG. 2 illustrates an example depiction 200 of multiple machine learning (ML) models running on a processing engine. In one example, the processing engine is a neural processing unit (NPU). In one example, a first ML model 210 and a first local memory 211 execute a first task at a first frame rate. In one example, a second ML model 220 and a second local memory 221 execute a second task at a second frame rate. In one example, a third ML model 230 and a third local memory 231 execute a third task at a third frame rate. In one example, the first frame rate, the second frame rate and the third frame rate are each different from the other. In another example, two of the frame rates may have the same value. In yet another example, all three frame rates have the same value.

In one example, the first ML model 210 has highest priority for execution and the second ML model 220 and the third ML model 230 have lower priority. In one example, the second ML model 220 and the third ML model 230 are interrupted and are subject to a context switch. In one example, the context switch flushes weights and activations of an ML model out of the second local memory 221 and the third local memory 231 and into an external memory (e.g., DDR memory) not shown. In one example, the weights and activations are read back repeatedly into the second local memory 221 and the third local memory 231.

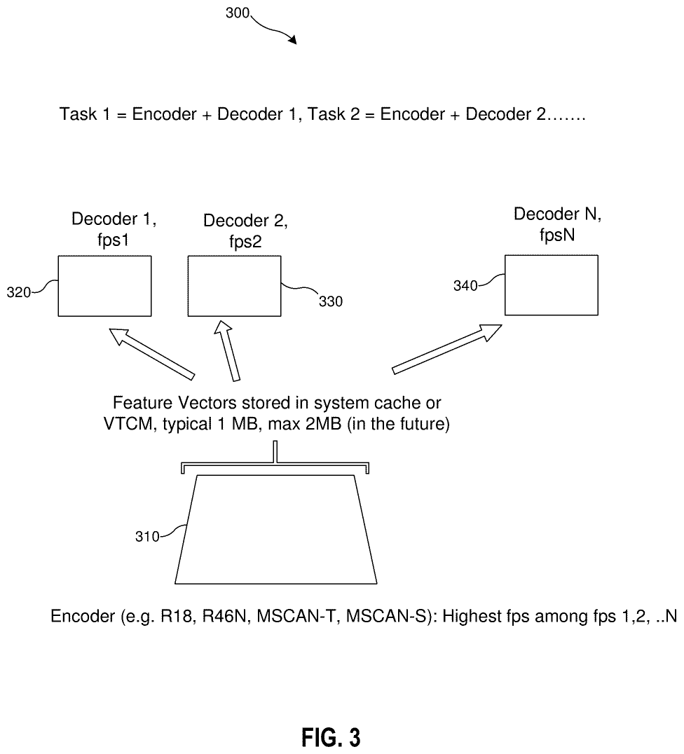

FIG. 3 illustrates an example multitask machine learning (ML) model 300 with a universal feature encoder in a local memory. In one example, the local memory is a non-transitory memory. In one example, the multitask ML model 300 includes a universal feature encoder 310 and a plurality of feature decoders including a first feature decoder 320, a second feature decoder 330 and so on until an Nth feature decoder 340. N is an integer indicating quantity. In one example, the universal feature encoder 310 is a common feature encoder shared among all tasks executed on the plurality of feature decoders. In one example, the universal feature encoder 310 is based on R18, R46N MSCAN-T, MSCAN-S, etc.

In one example, each feature decoder operates at a frame rate governed by an application used by a task. In one example, the first feature decoder 320 operates at a first frame rate, the second feature decoder 330 operates at a second frame rate and the Nth feature decoder 340 operates at an Nth frame rate. In one example, each of the frame rates has a different value from the other frame rates. In another example, some of the frame rates have the same value. In yet another example, all the frame rates have the same value. In one example, feature tensors may be stored in local memory for each decoder instead of external memory shared among all decoders. In one example, a feature is a characteristic of a physical object or entity (e.g., an image). In one example, a feature tensor is a mathematical or abstract representation of a feature which is suitable for mathematical operations (e.g., tensor multiplication, tensor addition, etc.).

In one example, a variety of feature encoders may be used in the multitask ML model. For example, the following table summarizes various resolution options for a plurality of feature encoders:

| encoder | Level 0 | Level 1 | Level 2 | Level 3 | Total |
|---|---|---|---|---|---|
| R18 | 64 × 72 × 120 | 128 × 36 × 60 | 256 × 18 × 30 | 512 × 9 × 15 | 1012 kB |
| R46N | 64 × 72 × 120 | 96 × 36 × 60 | 160 × 18 × 30 | 320 × 9 × 15 | 869 kB |
| MSCAN-T | 32 × 72 × 120 | 64 × 36 × 60 | 160 × 18 × 30 | 256 × 9 × 15 | 523 kB |
| MSCAN-S | 64 × 72 × 120 | 128 × 36 × 60 | 320 × 18 × 30 | 512 × 9 × 15 | 1046 kB |

In one example, level refers to a spatial resolution characteristic. In one example, the notation M×N×P for each table entry denotes a tensor dimension (in integers) being stored in local memory. This tables illustrates four example ML models with stored feature tensors.

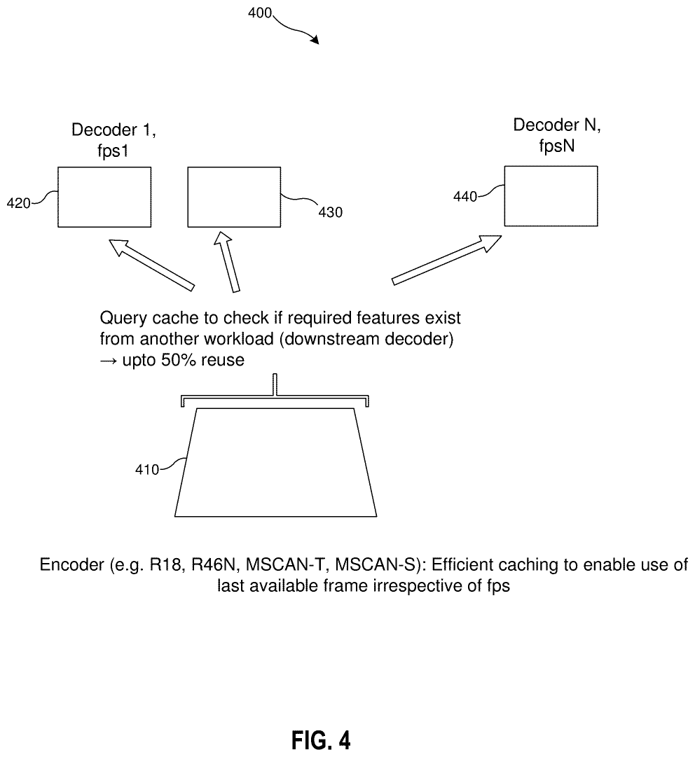

FIG. 4 illustrates an example multitask machine learning (ML) model 400 with caching of feature encoders. In one example, the multitask ML model 400 includes a universal feature encoder 410 and a plurality of feature decoders including a first feature decoder 420, a second feature decoder 430 and so on until an Nth feature decoder 440. N is an integer indicating quantity. In one example, the universal feature encoder 410 is a common feature encoder shared among all tasks executed on the plurality of feature decoders. In one example, the universal feature encoder 410 is based on R18, R46N MSCAN-T, MSCAN-S, etc.

In one example, each feature decoder operates at a frame rate governed by an application used by a task. In one example, the first feature decoder 420 operates at a first frame rate, the second feature decoder 430 operates at a second frame rate and the Nth feature decoder 440 operates at an Nth frame rate. In one example, each of the frame rates has a different value from the other frame rates. In another example, some of the frame rates have the same value. In yet another example, all the frame rates have the same value. In one example, feature tensors may be stored in local memory for each decoder instead of external memory shared among all decoders.

In one example, a local memory (e.g., cache memory or VTCM) of the universal feature encoder 410 may be queried to check if desired features for one workload (i.e., task) exist for another workload. In one example, the query is performed by a feature decoder. If true, caching to enable reuse of a last available frame is enabled, independent of the frame rate in use. That is, a high reuse factor (up to 50%) may be enabled.

In one example, a ML algorithm may be executed to provide a universal feature encoder. In one example, a key frame is a high priority frame (e.g., an anchor frame which is not skipped). In one example, the key frame is used as a reference for other frames in a plurality of frames. For example, the quantity of key frames is less than the quantity of total frames of the plurality of frames. For example, the following pseudocode illustrates one implementation for the universal feature encoder:

Given a plurality of ML tasks (e.g., assigned to different decoder tasks) running on a processing engine,

```
Execute N runs
    Identify task activation patterns given frame rate, regularity, etc.
    Execute M iterations
      Per selected key frame, compute
        First time it is injected in cache
        Last time it is queried by a task
      Identifying a cache lifetime per key frame feature
    Compute a maximum statistic for a quantity of alive key frame
  features per iteration
    Compute a mean statistic for feature reuse
  Return the maximum statistic and mean statistic over all N runs
```

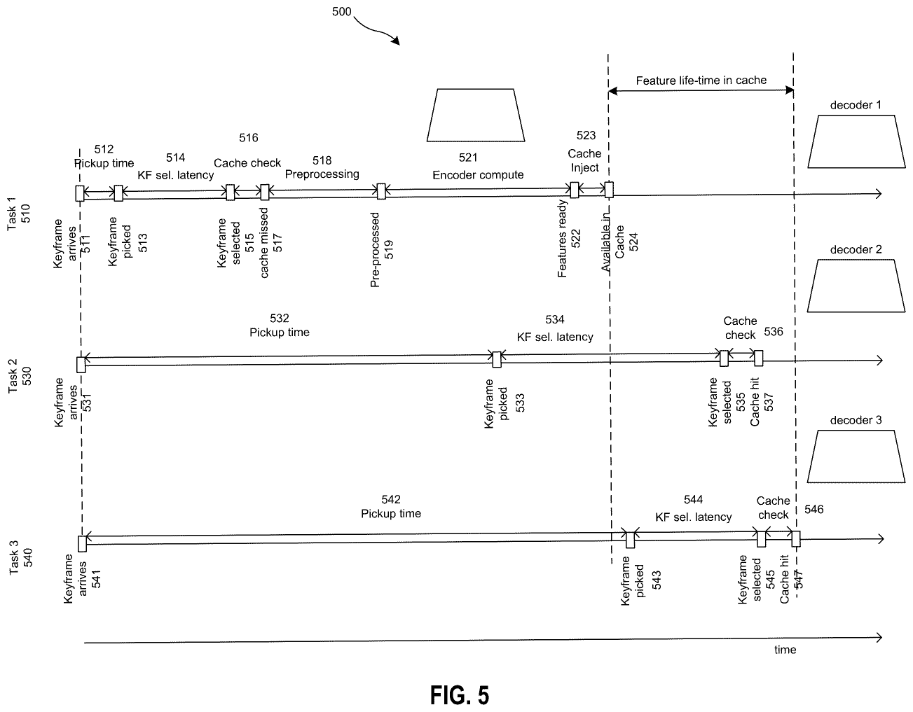

FIG. 5 illustrates an example timeline 500 for a plurality of machine learning (ML) tasks running on a processing engine. In one example, a first task 510, a second task 530 and a third task 540 are executed concurrently. In one example, the first task 510 commences with a key frame arrival 511. Next, a first pickup time 512 occurs with a first time duration. In one example, the first pickup time 512 is a time for a ML task to obtain a frame from an image source (e.g., camera). Next, a key frame is picked 513, followed by a first key frame selection latency period 514. Next, a key frame is selected 515, followed by a local (e.g., cache) memory check 516. Next, a cache miss 517 occurs, followed by a preprocessing time duration 518. Next, a preprocessing completion 519 occurs, followed by an encoder compute period 521. In one example, the encoder compute period 521 is a time duration where an encoder (i.e., backbone) performs an inference process. Next, features are ready 522, followed by a cache inject process 523. Next, the features are available in local memory 524. Subsequently, the features are maintained in local memory (i.e., cache memory) over a lifetime where the features may be reused by other tasks.

In one example, the second task 530 commences with the key frame arrival 531. Next, a second pickup time 532 occurs with a second time duration. Next, the key frame is picked 533, followed by a second key frame selection latency period 534. Next, the key frame is selected 535, followed by a local (e.g., cache) memory check 536. Next, a first cache hit 537 occurs. In one example, the first cache hit 537 occurs since the common feature has been placed in local memory by the first task 510.

In one example, the third task 540 commences with the key frame arrival 541. Next, a third pickup time 542 occurs with a third time duration. Next, the key frame is picked 543, followed by a third key frame selection latency period 544. Next, the key frame is selected 545, followed by a local (e.g., cache) memory check 546. Next, a second cache hit 547 occurs. In one example, the second cache hit 547 occurs since the common feature has been placed in local memory by the first task 510.

In one example, parametric results for the multitask ML model are summarized in the following table:

| | | | Pickup | |
|---|---|---|---|---|
| | | Frame rate, | delay | Algorithmic |
| Task name | Regular? | fps | (range), ms | delay, ms |
| Depth estimation | x | 5 | (1, 10) | 2 |
| Semantic segmentation | x | 5 | (3, 12) | 1 |
| Dynamic guardian | ✓ | 16 | (1, 10) | 0 |
| Local descriptors- | ✓ | 5 | (1, 10) | 0 |
| localization | | | | |
| Local descriptors-mapping | ✓ | 30 | (1, 5) | 0 |

In one example, pickup delay is an acquisition time for a frame. In one example, algorithmic delay is an encoder computation time.

In one example, the multitask ML model may use global parameters such as candidate frames per second=30, preprocessing time=11 ms, cache check time=1 ms, cache injection time=1 ms, R46 encoder latency=6 ms. In one example, the maximum queue size is 1 and a reuse factor of 50% is achieved.

In one example, a sample parameterization that increases the cache memory size maintains the above parameters except increasing pickup delay to (1,20) and increasing the global frame rate to 60 fps (e.g., a global inverse relation with reuse). In one example, the maximum queue size is 2 and a reuse factor of 46% is achieved.

In one example, with the multitask ML model, an overall cache memory size may be no greater than 2 MB (e.g., two feature maps) such that storing 2 MB of features in local memory is feasible. In one example, external memory bandwidth may be reduced by the reuse factor (e.g., 50%) which reduces external memory dc power consumption by 50% and improves memory latency by 10%.

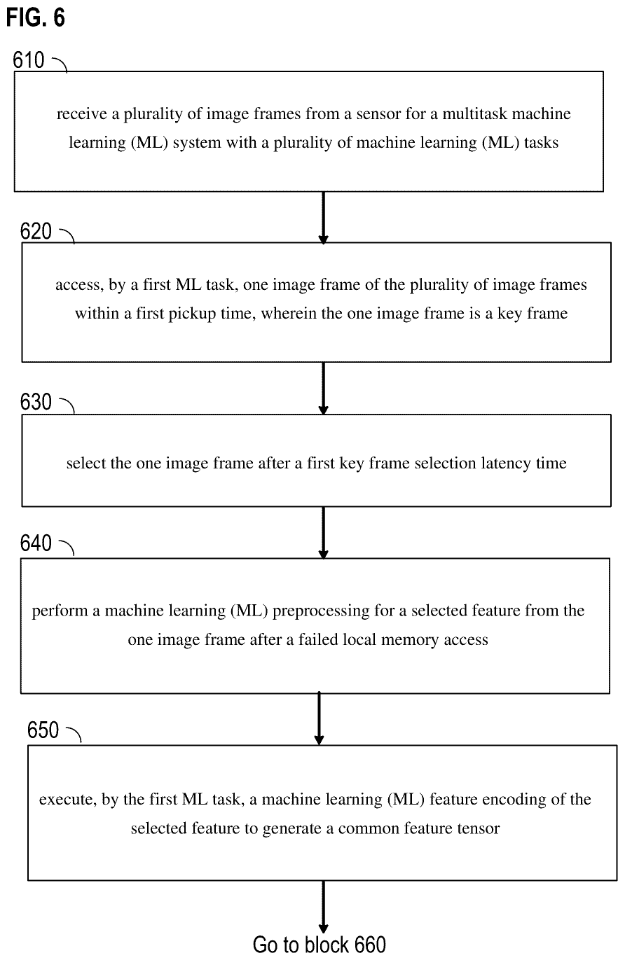

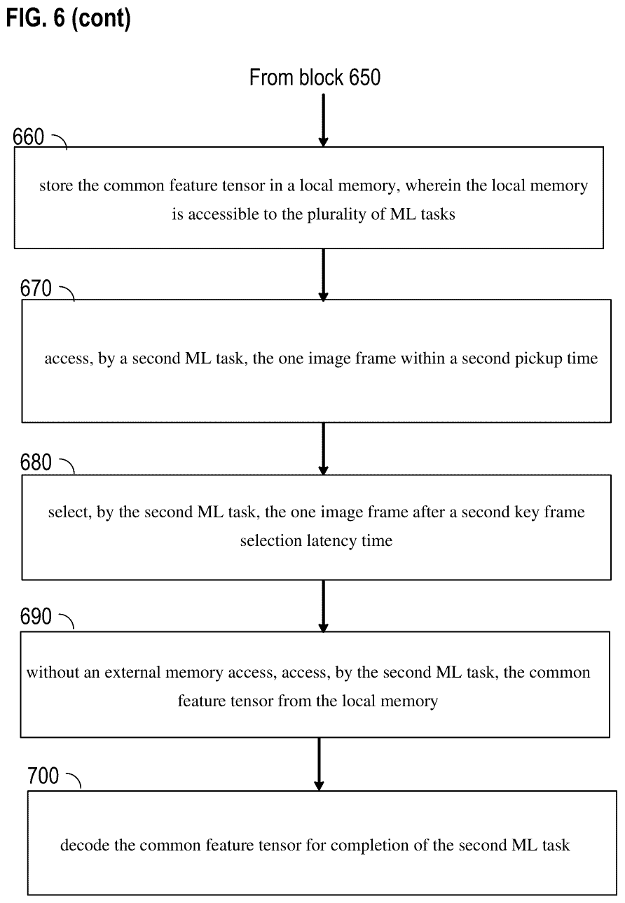

FIG. 6 illustrates an example flow diagram 600 for implementing a multitask machine learning (ML). In block 610, receive a plurality of image frames from a sensor for a multitask machine learning (ML) system with a plurality of machine learning (ML) tasks. In one example, a plurality of image frames is received from a sensor for a multitask machine learning (ML) system with a plurality of machine learning (ML) tasks.

In one example, the sensor is a camera, image sensor or video sensor. In one example, each image frame from the plurality of image frames is a two-dimensional data structure with a plurality of pixels. In one example, the plurality of image frames are received at a frame rate, measured in frames per second. In one example, the reception of the plurality of image frames is performed by a display processing unit (DPU). In other examples the step of block 610 may be performed by one of the following: a CPU, a DPU, a GPU, a processing engine coupled to a non-transitory memory, etc.

In block 620, access, by a first ML task, one image frame of the plurality of image frames within a first pickup time, wherein the one image frame is a key frame. In one example, by a first ML task, one image frame of the plurality of image frames is accessed within a first pickup time, wherein the one image frame is a key frame.

In one example, the one image frame (i.e., the key frame) is an anchor frame used as a reference for subsequent image frames. In one example, the first pickup time is a time duration for delivery of an image frame from the sensor. In one example, the access of the one image frame (i.e., the key frame) is performed by a neural processing unit (NPU). In other examples, the step of block 620 may be performed by one of the following: a CPU, a DPU, a GPU, a processing engine coupled to a non-transitory memory, etc.

In block 630, select the one image frame after a first key frame selection latency time. In one example, the one image frame is selected after a first key frame selection latency time. The one image frame is the key frame. In one example, selection of the key frame is an ingestion of the key frame by a processing engine. In one example, the selection of the key frame is performed by the NPU. In other examples the step of block 630 may be performed by one of the following: a CPU, a DPU, a GPU, a processing engine coupled to a non-transitory memory, etc.

In block 640, perform a machine learning (ML) preprocessing for a selected feature from the one image frame after a failed local memory access. In one example, a machine learning (ML) preprocessing is performed for a selected feature from the one image frame after a failed local memory access. In one example, the ML preprocessing performs initialization and format conversion prior to subsequent ML processing. In one example, the ML preprocessing may include downscaling, resampling, decompression, denoising, etc. In one example, the ML preprocessing is performed by the NPU. In other examples the step of block 640 may be performed by one of the following: a CPU, a DPU, a GPU, a processing engine coupled to a non-transitory memory, etc.

In block 650, execute, by the first ML task, a machine learning (ML) feature encoding of the selected feature to generate a common feature tensor. In one example, by the first ML task, a machine learning (ML) feature encoding of the selected feature is executed to generate a common feature tensor. In one example, the common feature tensor is a multidimensional data structure with one or more attributes (or categories), such as color, size, etc., of an entity in a machine learning (ML) model. In one example, the common feature tensor is a feature tensor which may be used by the plurality of ML tasks. In one example, the ML feature encoding may use an encoding algorithm with a specified spatial resolution and frame rate. In one example, the ML feature encoding includes an ML inference. In one example, the ML feature encoding is performed by the NPU. In other examples the step of block 650 may be performed by one of the following: a CPU, a DPU, a GPU, a processing engine coupled to a non-transitory memory, etc.

In block 660, store the common feature tensor in a local memory, wherein the local memory is accessible to the plurality of ML tasks. In one example, the common feature tensor is stored in a local memory. In one example, the local memory is a cache memory. In one example, the local memory is a vector tightly coupled memory (VTCM). In one example, the local memory is a non-transitory memory.

In block 670, access, by a second ML task, the one image frame within a second pickup time. In one example, by a second ML task, the one image frame is accessed within a second pickup time. In one example, the access of the one image frame (i.e., the key frame) is performed by the NPU. In other examples the step of block 670 may be performed by one of the following: a CPU, a DPU, a GPU, a processing engine coupled to a non-transitory memory, etc.

In block 680, select, by the second ML task, the one image frame after a second key frame selection latency time. In one example, by the second ML task, the one image frame is selected after a second key frame selection latency time. In one example, the selection of the one image frame (i.e., the key frame) is performed by the NPU. In other examples the step of block 680 may be performed by one of the following: a CPU, a DPU, a GPU, a processing engine coupled to a non-transitory memory, etc.

In block 690, without an external memory access, access, by the second ML task, the common feature tensor from the local memory. In one example, without an external memory access, the common feature tensor is accessed by the second ML task from the local memory. In one example, the access of the common feature tensor is performed by the NPU. In other examples the step of block 690 may be performed by one of the following: a CPU, a DPU, a GPU, a processing engine coupled to a non-transitory memory, etc.

In block 700, decode the common feature tensor for completion of the second ML task. In one example, the common feature tensor is decoded for completion of the second ML task. In one example, the decoding of the common feature tensor is performed by the NPU. In other examples the step of block 700 may be performed by one of the following: a CPU, a DPU, a GPU, a processing engine coupled to a non-transitory memory, etc.

In one aspect, one or more of the steps for providing multitask machine learning (ML) in FIG. 6 may be executed by one or more processors which may include hardware, software, firmware, etc. The one or more processors, for example, may be used to execute software or firmware needed to perform the steps in the flow diagram of FIG. 6. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. An apparatus comprising:
a non-transitory memory for storage of a common feature tensor;
a processing engine coupled to the non-transitory memory, the processing engine configured to:
a) execute, by a first machine learning (ML) task, a machine learning (ML) feature encoding of a selected feature to generate the common feature tensor;
b) without an external memory access, access by a second machine learning (ML) task the common feature tensor from the non-transitory memory, wherein the non-transitory memory is a local memory; and
c) decode the common feature tensor for completion of the second ML task.

2. The apparatus of claim 1, wherein the processing engine is further configured to use an encoding algorithm with a specified spatial resolution and frame rate for executing the machine learning (ML) feature encoding.

3. The apparatus of claim 2, wherein the processing engine is further configured to:
access, by the second ML task, one image frame of a plurality of image frames within a first pickup time; and
select, by the second ML task, the one image frame after a first key frame selection latency time.

4. The apparatus of claim 3, wherein the processing engine is further configured to:
perform a machine learning (ML) preprocessing for a selected feature from the one image frame after a failed local memory access; and
select the one image frame after a second key frame selection latency time.

5. A method comprising:
executing, by a first machine learning (ML) task, a machine learning (ML) feature encoding of a selected feature to generate a common feature tensor;
without an external memory access, accessing, by a second machine learning (ML) task, the common feature tensor from a local non-transitory memory; and
decoding the common feature tensor for completion of the second ML task.

6. The method of claim 5, wherein the ML feature encoding uses an encoding algorithm with a specified spatial resolution and frame rate.

7. The method of claim 5, wherein the common feature tensor is a multidimensional data structure with one or more attributes of an entity in a machine learning (ML) model.

8. The method of claim 5, further comprising storing the common feature tensor in the local non-transitory memory.

9. The method of claim 8, wherein the local non-transitory memory is accessible to a plurality of machine learning (ML) tasks.

10. The method of claim 8, further comprising accessing, by the second ML task, one image frame of a plurality of image frames within a first pickup time.

11. The method of claim 10, wherein the one image frame is an anchor frame used as a reference for subsequent image frames of the plurality of image frames.

12. The method of claim 10, further comprising selecting, by the second ML task, the one image frame after a first key frame selection latency time.

13. The method of claim 12, further comprising performing a machine learning (ML) preprocessing for a selected feature from the one image frame after a failed local memory access.

14. The method of claim 13, further comprising selecting the one image frame after a second key frame selection latency time.

15. The method of claim 14, further comprising accessing, by the first ML task, the one image frame within a second pickup time.

16. The method of claim 15, further comprising receiving the plurality of image frames from a sensor for a multitask machine learning (ML) system with the plurality of machine learning (ML) tasks.

17. A non-transitory computer-readable medium storing computer executable code, operable on a device comprising at least one processor and at least one memory coupled to the at least one processor, wherein the at least one processor is configured to implement multi-task learning, the computer executable code comprising:
instructions for causing a computer to execute, by a first machine learning (ML) task, a machine learning (ML) feature encoding of a selected feature to generate a common feature tensor;
instructions for causing the computer to, without an external memory access, access by a second machine learning (ML) task the common feature tensor from a local non-transitory memory;
instructions for causing the computer to decode the common feature tensor for completion of the second ML task; and
instructions for causing the computer to store the common feature tensor in the local non-transitory memory.

18. The non-transitory computer-readable medium of claim 17, further comprising:
instructions for causing the computer to access, by the second ML task, one image frame of a plurality of image frames within a first pickup time; and
instructions for causing the computer to select, by the second ML task, the one image frame after a first key frame selection latency time.

19. The non-transitory computer-readable medium of claim 18, further comprising instructions for causing the computer to perform a machine learning (ML) preprocessing for a selected feature from the one image frame after a failed local memory access.

20. The non-transitory computer-readable medium of claim 19, further comprising:
instructions for causing the computer to elect the one image frame after a second key frame selection latency time; and
instructions for causing the computer to access, by the first ML task, the one image frame within a second pickup time.
